(19) United States
(12) Patent Application Publication
(10) Pub. No.: US 2025/0321811 A1
(43) Pub. Date: Oct. 16, 2025

(54) Computer System and Method for Queuing Events for Asynchronous Consumption

(71) Applicant: Shopify Inc., Ottawa (CA)

(72) Inventor: Sophie ORTA, Perth (CA)

(73) Assignee: Shopify Inc., Ottawa (CA)

(21) Appl. No.: 18/631,444

(22) Filed: Apr. 10, 2024

(51) Int. Cl. G06F 9/54; G06F 9/38

(52) U.S. Cl. CPC G06F 9/546; G06F 9/3871; G06F 9/542; G06F 2209/548

(57) ABSTRACT

A system and method are provided for queueing events based on interactions with computer applications for asynchronous consumption. The method includes obtaining events based on interactions with a web browser; and queueing the obtained events for each of the events. The queuing includes, for a given event: identifying, from amongst a plurality of in-memory queues based on the given event, an in-memory queue in which to queue the given event; and queuing the given event in the identified in-memory queue. The events queued in the queues of the plurality of in-memory queues are queued for asynchronous consumption.

### TECHNICAL FIELD

The following generally relates to queueing events, in particular to queueing events based on interactions with computer applications for asynchronous consumption.

### BACKGROUND

Event monitoring services exist that may deploy and run scripts (e.g., using JavaScript code) in an application such as a web browser to monitor events. For example, in a web browser, such an event monitoring service may monitor document object model (DOM)-related events and transmit these to a server.

### BRIEF DESCRIPTION OF THE DRAWINGS

Embodiments will now be described with reference to the appended drawings wherein:

FIG. 1 is an example of a computing environment in which a software platform provides applications that may be analyzed by an analytics engine.

FIG. 2 illustrates an application having multiple queues consuming events determined using a script.

FIG. 3 illustrates a tenant domain providing multiple applications via a software platform that are analyzed by an analytics engine.

FIG. 4 illustrates an isolated environment within an application used to deploy a script and utilize event monitoring service.

FIG. 5 illustrates a secure sandbox environment deployed in a web browser and used to deploy a script and utilize an event monitoring service.

FIG. 6 is an example of a computing device operable to communicate in the computing environment.

FIG. 7a is a flow chart illustrating example operations performed in queueing events for asynchronous consumption.

FIG. 7b is a flow chart illustrating example operations performed in queueing events to one of a plurality of in-memory queues.

FIG. 8 is a flow chart illustrating example operations performed in isolating event detection scripts in an isolated environment such as a secure sandbox.

FIG. 9 is a flow chart illustrating example operations performed in managing a queue based on a defined maximum size.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

There may be multiple different categories of events that occur in the course of interactions with applications such as a web browser. These different categories of events may occur with different priorities and according to different frequencies. As such, there may be an event of high importance that occurs occasionally and an event of low importance that occurs frequently. If such events are all in the same queue, and the queue gets backed up, or fills up before it is able to send to a server (or other monitoring entity), there may be a risk of the event of high importance being lost, discarded, or disregarded.

It has been recognized that a differentiated quality of service may be applied to multiple event queues, for example in a web browser, to ensure that higher priority events are prioritized in the manner in which they are stored and delivered. The differentiated quality of service may be achieved by queuing up events into selected ones of multiple in-memory queues for asynchronous consumption, e.g., by having asynchronous transmissions of events to a remote server. Put another way, the differentiated quality of service may be achieved by applying different “delivery semantics” to each of multiple in-memory queues. Asynchronous consumption, as used herein, may refer to differentiated queueing metrics, parameters, rules, logic, or standards applied to events to assign a given event to a particular one of a plurality of queues. Such events may be distinguishable based on a characteristic, feature, type, or assigned value such that an event may be identified as belonging to a specific in-memory queue and a set of events may be treated individually and asynchronously for processing with respect to the assigned queue, including according to certain delivery semantics. The delivery semantics may be associated with the asynchronous consumption in addition to other factors like queue size, queue element expiration, etc.

Differentiation of the delivery semantics and use of same in, for example, asynchronous consumption as herein described, may be based on various factors associated with an event type. For example, user interface (UI) events may have a different priority than application events, versus standard browser events that may apply to any web page (e.g., DOM-related events such as user clicks, web page loads, image loads, mouse movement/dwell over an element, input field changes, user key presses, etc.). It can be appreciated that the system described herein may utilize two levels of priority, or more than two. The system described herein may, additionally or alternatively, use a single level of priority with at least one other metric used to determine into which queue to place an event, e.g., event type, timestamp, application type, etc.

Browser events may be stored in separate in-memory queues (also referred to herein as “queues” for brevity) by an event detection script, an application-side event monitoring service (or both), before being processed by a separate (e.g., external) entity such as an analytics engine or by a server-side monitoring service. Separate queues with different maximum sizes may be used. For example, a lower priority queue may have a maximum storage size, designated storage time, or may apply certain sampling or filtering criteria.

The queue may be used as a replay queue that records events immediately when the browser page loads, that are later transmitted to the server. Other queues may transmit events more immediately. By having multiple in-memory queues to store detected events, any number or type of delivery semantics may be applied according to the event type to allow for customizability to the event monitoring service, the analytics engine, or both. The event monitoring service may allow subscribers (e.g., multiple different analytics engines, administrators or monitoring services) to choose which of the different event queues to subscribe to, and this may be customizable via the event monitoring service. Events may be pushed or pulled to/from the event monitoring service.

In an example implementation, a web browser application may have both high level (or high importance) events (e.g., based on business logic such as adding items to cart), as well as low level (or low importance) events based on standard or common web browser events (e.g., DOM-related events such as clicks, scrolls, dwells/hovers, etc.). In this case, a two level priority system may be implemented as two queues in the browser memory. As events occur, they may be added to the appropriate queue. If the queue contents are not transmitted immediately, the events may be added to the queues. In the system described herein, asynchronous consumption may be achieved by assigning the DOM-related events to an in-memory queue having a maximum size, such that the oldest events may be deleted if the DOM-related queue is full, without affecting the high level events stored in a different in-memory queue.

The event detection script and/or event monitoring service used to detect events may be securely isolated (e.g., sandboxed) from the raw events running in the browser. This enables the script and/or event monitoring service to be provided as, or within, an abstraction layer. In this way, the receivers/subscribers of the events and any metadata or reports associated with the events may not see the raw data associated with, e.g., DOM-related events or tags, but instead see the abstract events defined by the sandboxed script and/or event monitoring service. The secure isolation (e.g., by sandboxing) may be applied for customizability and separability and/or to address security concerns with the event script, event monitoring service, and/or analytics engine having access to raw data associated with browser events as described in greater detail below.

In one aspect, there is provided a computer-implemented method, comprising: obtaining events based on interactions with a web browser; and queueing the obtained events for each of the events, the queuing comprising, for a given event: identifying, from amongst a plurality of in-memory queues based on the given event, an in-memory queue in which to queue the given event; and queuing the given event in the identified in-memory queue; wherein the events queued in the queues of the plurality of in-memory queues are queued for asynchronous consumption.

In certain example embodiments, the obtained events are generated based on interactions with the web browser.

In certain example embodiments, the interactions with the web browser are detected by an event detection script or event monitoring service securely isolated from the web browser, the event detection script or event monitoring service used to queue events according to one or more delivery semantics associated with the asynchronous consumption.

In certain example embodiments, the event detection script or event monitoring service is securely isolated from the web browser using an inline frame.

In certain example embodiments, the event detection script or event monitoring service is securely isolated from the web browser using a secure sandbox.

In certain example embodiments, the identified in-memory queue comprises events queued for responding to a replay request.

In certain example embodiments, the identified in-memory queue is identified based on a type of the given event.

In certain example embodiments, queueing the given event in the identified in-memory queue comprises, prior to adding the given event to the identified in-memory queue: determining that the identified in-memory queue has reached a defined maximum size; and discarding at least one event from the in-memory queue.

In certain example embodiments, the discarded at least one event from the identified in-memory queue is selected based on a position of the at least one event in the identified in-memory queue.

In certain example embodiments, the asynchronous consumption comprises asynchronous transmissions of events to a remote server.

In certain example embodiments, at least some of the obtained events correspond to DOM-related events.

In certain example embodiments, the identified in-memory queue has a relatively higher capacity than at least one other in-memory queue of the plurality of in-memory queues.

In certain example embodiments, the at least one other in-memory queue is associated with at least one other event type having a relatively lower priority than a type of the given event.

In certain example embodiments, the plurality of in-memory queues comprises three or more event queues including the identified in-memory queue, at least some of the three or more in-memory queues having a different priority level.

In certain example embodiments, each of the three or more in-memory queues comprises a corresponding capacity based on a corresponding priority level.

In certain example embodiments, each of the three or more in-memory queues transmits events to a remote server asynchronously based on a corresponding priority level.

In another aspect, there is provided a computer system comprising: at least one processor; and at least one memory. The at least one memory includes processor executable instructions that, when executed by the at least one processor, cause the computer system to: obtain events based on interactions with a web browser; and queue the obtained events for each of the events, the queuing comprising, for a given event: identifying, from amongst a plurality of in-memory queues based on the given event, an in-memory queue in which to queue the given event; and queuing the given event in the identified in-memory queue; wherein the events queued in the queues of the plurality of in-memory queues are queued for asynchronous consumption.

In certain example embodiments, the obtained events are generated based on interactions with the web browser.

In certain example embodiments, the interactions with the web browser are detected by an event detection script or event monitoring service securely isolated from the web browser, the event detection script or event monitoring service used to queue events according to one or more delivery semantics associated with the asynchronous consumption.

In another aspect, there is provided a computer-readable medium comprising processor executable instructions that, when executed by a processor of a computer system, cause the computer system to: obtain events based on interactions with a web browser; and queue the obtained events for each of the events, the queuing comprising, for a given event: identifying, from amongst a plurality of in-memory queues based on the given event, an in-memory queue in which to queue the given event; and queuing the given event in the identified in-memory queue; wherein the events queued in the queues of the plurality of in-memory queues are queued for asynchronous consumption.

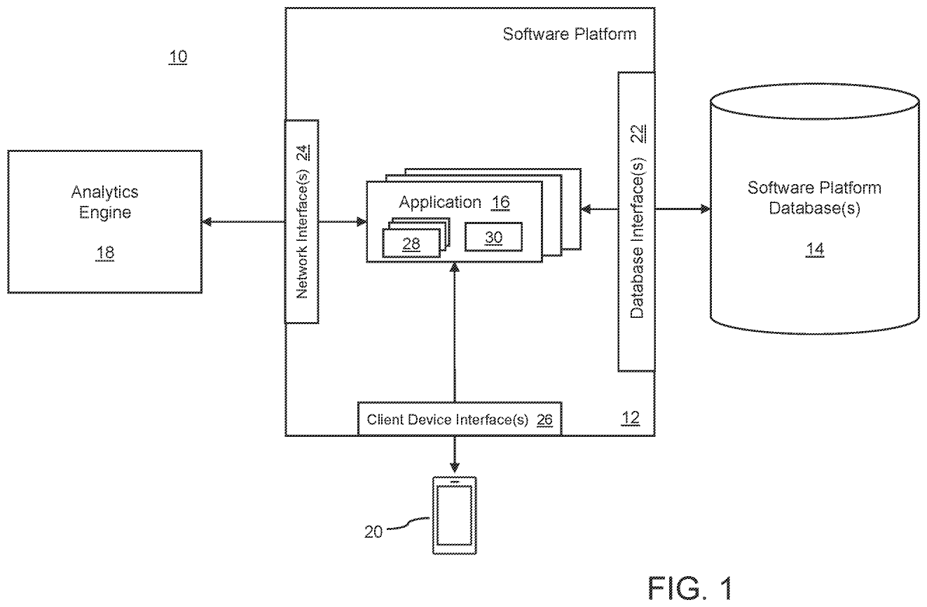

Turning now to the figures, FIG. 1 illustrates an example of a computing environment 10. The computing environment 10 in this example includes a software platform 12, which may be adapted as a software as a service (SaaS) platform such as, for example, an e-commerce platform, a media distribution platform, a security infrastructure platform, etc.

The software platform 12 includes or otherwise has access to one or more software platform databases 14. The database(s) 14 may include one or more database tables or shards, libraries, data storage elements or any other allocation of memory used to store data, access such data, and enable mutations of such data. The software platform 12 may communicate with, or otherwise be coupled to, one or more computing devices 20, in this example depicted as a personal electronic device such as a smart phone. It can be appreciated that only a single client device 20 is shown in FIG. 1 for illustrative purposes and various numbers of such devices 20 may be coupled to the software platform 12 via, for example, a network or other electronic communication connection.

The entities and elements shown in FIG. 1 may therefore communicate or otherwise be coupled to each other via one or more communication connections, which may utilize one or more short- or long-range communication network protocols, described by way of example below.

The software platform 12 in this example includes, among other things not shown for ease of illustration, one or more applications 16, which are hosted or otherwise provided by the software platform 12. At least one of the applications 16 may be coupled to the software platform database 14. For example, the application 16 may provide data and/or service(s) to entities via a client device 20, of which data is accessed or otherwise retrieved from the database 14. In the example shown in FIG. 1, multiple applications 16 are shown for illustrative purposes, however, it can be appreciated that the software platform 12 may be configured to provide a single application 16 or multiple applications 16, e.g., for providing multiple types of services or to provide access to data in the database 14 for multiple corresponding purposes.

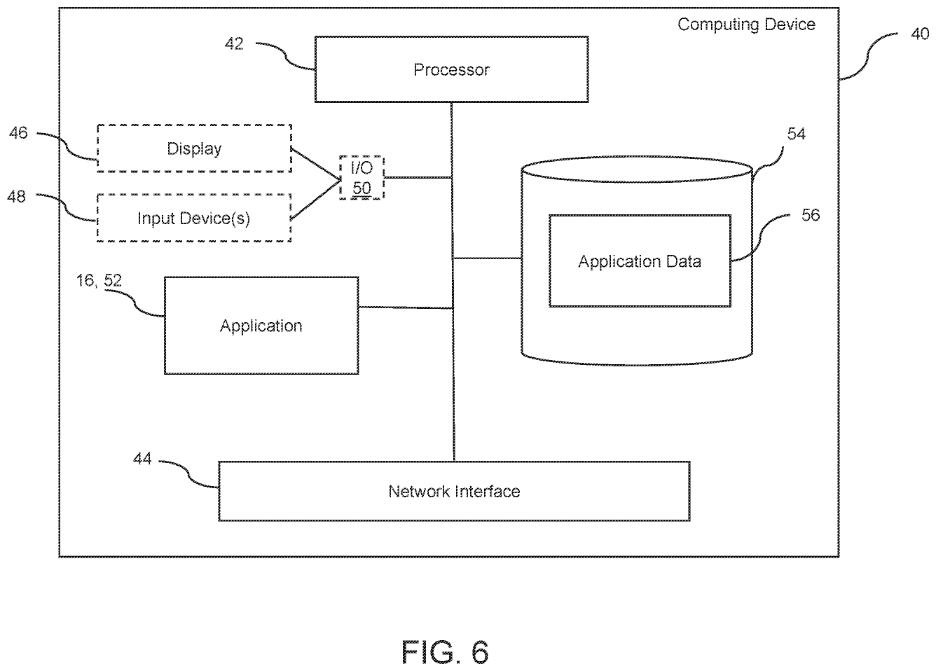

The application(s) 16 may be interacted with by entities using a client device 20, via one or more client device interfaces 26. The application(s) 16 may communicate with the database 14 via one or more database interfaces 24. It can be appreciated that the client device interface(s) 26 may enable communication via one or more networks. Such network connections are described further below in connection with FIG. 6.

The computing environment 10 may also include an analytics engine 18. The analytics engine 18 may communicate and interact with the software platform 12, including the one or more applications 16, via one or more network interfaces 24. It can be appreciated that the network interface(s) 24 and client device interface(s) 26 may be similar, the same or otherwise utilize the same or similar network communication protocols and are shown separately in FIG. 1 for illustrative purposes.

The analytics engine 18 may be associated with the software platform 12 (e.g., as a separate service within the same enterprise) or may be provided by an external, third party service. The analytics engine 18 as shown in FIG. 1 represents any entity that may be considered separate from an application 16 for which data is obtained and consumed to perform at least one analytics operation. For example, as described by way of example here, the analytics engine 18 may be utilized to analyze events triggered by interactions with an application 16 such as a web browser to perform a service for an entity associated with that application 16 (e.g., a tenant of the software platform 12). The analytics engine 18 may be hosted or otherwise provided by a computing device such as a server device, details of which are shown in FIG. 6 and described below by way of example. While shown as a separate entity in FIG. 1, it can be appreciated that the analytics engine 18 may, alternatively or additionally, be hosted by or within the software platform 12 or deployed within an application 16.

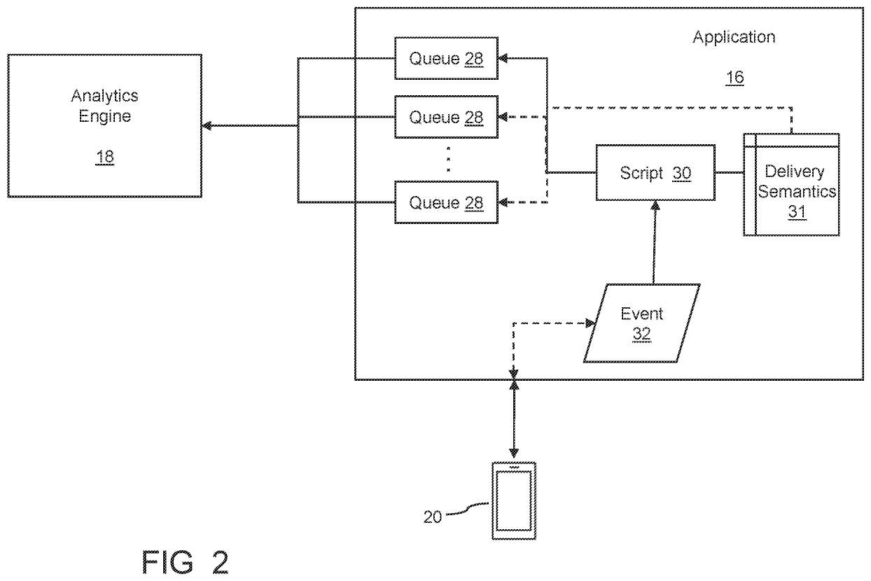

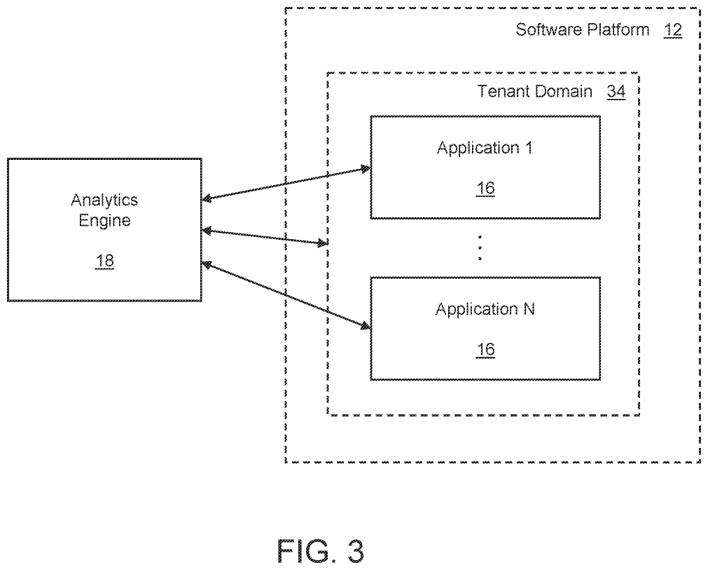

An application 16 provided by the software platform 12 may include multiple in-memory queues 28 used to store events detected or consumed by an event detection script 30, herein also referred to as a “script” 30 for brevity. The in-memory queues 28 may, in this example, store events 32 (see also FIG. 2) for asynchronous consumption by the analytics engine 18, which may include applying differentiated delivery semantics to each of the queues 28. The script 30 may be utilized as an event monitoring service 35 (e.g., see FIG. 3) or be associated with such an event monitoring service 35 as shown by way of example below. The script 30 may represent any computer routine, function, module or other executable computer code that operates to perform a task associated with detecting, receiving, observing or otherwise obtaining data, metadata or other information associated with an event 32. An example of a script 30 may include a Pixel™, App Pixel™, JavaScript™ snippet, etc. While a single event detection script 30 is shown in FIG. 1 for illustrative purposes, it can be appreciated that, as described further below, multiple scripts 30 may be utilized for event monitoring and such scripts 30 may feed multiple in-memory queues 28. There may be multiple queues 28 for each script 30 or some queues 28 may overlap and be utilized by multiple different scripts 30. In one example, a queue 28 may be utilized as a replay queue 28 wherein events 32 are stored upon initiation of an application session for error handling or to return to previous steps or operations in a workflow. A replay queue 28 may be configured to have a size and/or transmission schedule that suits a typical reply sequence required to replay a session, portion of a session, or otherwise return to an appropriate point in a workflow.

FIG. 2 illustrates an application 16 that utilizes an event detection script 30 for monitoring events 32 that are triggered by interactions with the application 16, e.g., by a user of a client device 20. The events 32 may, additionally or alternatively, be triggered by other occurrences associated with the application 16, such as actions, inputs, or outputs that are triggered by other entities within or external to the application 16 or software platform 12. In this example an arbitrary N number of queues 28 are shown, each being coupled to or otherwise accessible by the analytics engine 18 for asynchronous consumption.

By having multiple in-memory queues 28 as shown, the script 30 may categorize events 32 based on an event type, a priority, a timing factor or some other parameter to determine into which queue 28 the event 32 should be stored. When referring herein to an event 32 being stored in a queue 28, it can be appreciated that this may include storing the event 32 itself, metadata, tags, or other indications of the occurrence of the event 32, or other information associated with the event 32. That is, the event 32 and its storage in a particular queue 28 may take any suitable form that is, for example, capable of providing at least some information about or concerning the event 32 and be identifiable from other events 32.

The script 30 may determine into which queue 28 to add an event 32 by referring to delivery semantics 31, which may include a set of rules or logic that may be referenced to determine how to route the events 32 into the queues 28. For example, the delivery semantics 31 may specify a queue 28 associated with each of a plurality of event types. The delivery semantics 31 may, additionally or alternatively, route an event 32 to a particular queue 28 based on a relative priority, e.g., mandatory, high priority, normal priority, low priority, no priority (e.g., discard), etc.

The in-memory queue 28 may include a set of parameters. For example, a queue 28 may include a fixed or maximum storage capacity such that adding events 32 to that queue 28 may cause previously queued events 32 to be discarded. A queue 28 may, additionally or alternatively, include a timing-related parameter. For example, a queue 28 assigned to higher priority events 32 may transmit its contents to the analytics engine 18 more often than a queue 28 assigned to lower priority events 32.

It can be appreciated that the priority or importance of an event 32 may be based on its event type or some other factor such as its origin, when it is detected or any other determined factor that may be included in the rules or logic defining the delivery semantics 31. The delivery semantics 31 may, additionally or alternatively, be accessible to the queues 28 as shown by way of a dashed line in FIG. 2. That is, the delivery semantics 31 may be a separate allocation or may be woven into the logic utilized by the script 30 and/or queue 28.

In an example implementation, assume two queues 28, Q1 and Q2 represented by the following arrays, each having a different size (i.e., event capacity):
Q1[0,0,0,0,0,0], and Q2[0,0,0].

In this example, Q1 may be designated for higher priority events and may hold more events than Q2, having a relatively lower priority. If one assumes the same delivery schedule, e.g., hourly, Q2 may be required to discard events, e.g., by applying a first in first out (FIFO) paradigm. In this way, not only may the application 16 reduce its memory requirements for lower priority events, Q2 may hold only the most recent events, which in this example may be more important than necessarily having access to all low priority events.

Assuming an event stream of E1, E2, E3, E4, E5, E6, E7, E8, with E2, E4, E6, and E8 being low priority events, Q1 and Q2 would be populated as follows at the time of detecting and queueing E8:
Q1[E1, E3, E5, E7, 0, 0], and Q2[E2, E4, E6]=>Q2[E4, E6, E8].

Here it can be seen that E2 was discarded upon detecting E8 since Q2 was already full and the first in became the first out.

If Q1 and Q2 are scheduled to be transmitted to the analytics engine 18 at the same time, e.g., following E8 but before E9, the contents of Q1 and Q2, as indicated above, may be sent with Q1 being less than full at the time of transmission. After emptying the queues 28, the sequence may continue.

In another example, Q1 and Q2 may be transmitted only when Q1 is full, in which case at least two additional higher priority events 32 are detected and placed in Q1 before the contents are transmitted, wherein additional lower priority events 32 may have been detected and earlier ones discarded in the meantime.

Referring now to FIG. 3, in other examples, the software platform 12 may provide a multi-tenant domain for one or more tenants 34. The tenants 32 may be associated with enterprises such as merchants, service providers, etc. The software platform 12 may, for example, enable the applications 16 to be configured, programmed, developed, or adapted to each of multiple tenants 34 such that the tenant 34 may customize the application 16 in a way that allows that tenant 34 to utilize the software platform 12 for their desired purposes. For example, the software platform 12 may provide storefront applications 16 for merchants that may adapt the storefront application 16 to provide particular goods and services.

As shown in FIG. 3, the analytics engine 18 may be configured to communicate with the software platform 12 and/or a tenant domain 34 hosted by the software platform 12. The tenant domain 34 in this example includes an arbitrary N number of applications 16, namely Application 1, . . . , Application N.

The analytics engine 18 may, therefore, communicate with multiple different applications 16 associated with the same tenant domain 34. For example, a merchant may utilize multiple different applications 16 provided by the software platform 12 to create a storefront for their customers. The analytics engine 18 may include multiple individual subscriptions to a particular tenant domain 34, each tailored to a particular application 16 hosted by or for that tenant domain 34.

It can be appreciated that the applications 16 shown in FIG. 3 may each be configured in a manner similar to that shown in FIG. 2 and described above or according to other examples provided below. Moreover, one or more of the applications 16 may be configured in such a way to utilize event monitoring while having other applications 16 that do not. The analytics engine 18 may therefore provide multi-layered subscriptions to different tenants on the software platform 12 according to a type of tenant domain 34 being used.

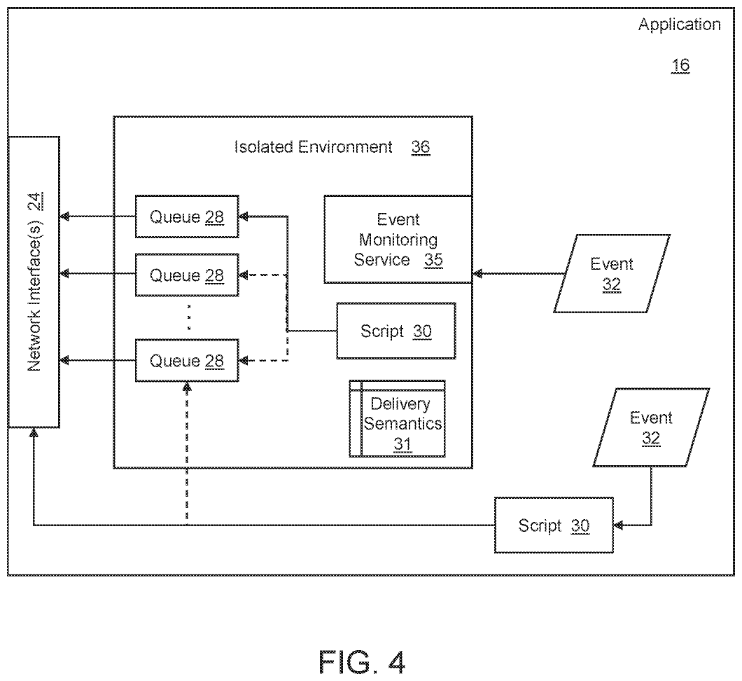

The application 16 may, additionally or alternatively, utilize an isolated environment 36 in which to execute event monitoring and event detection operations as shown in FIG. 4. The isolated environment 36 may provide a secure zone using, for example, an inline frame, a secure sandbox or any other similar secure boundary, zone, or isolated area within the application 16. The isolated environment 36 may be used to segregate an event detection script 30 and/or an event monitoring service 35 from the raw data and events 32 occurring within the application 16 to provide an abstraction layer for the event monitoring service 35 and analytics engine 18. For example, an inline frame or sandbox may be used to capture events 32 associated with interactions with a particular portion of the application 16, e.g., a webform, payment or other area of relatively higher importance to the entity. In this way, the event monitoring operations may be provided in a more secure manner, thus protecting the application 16 from unwanted activity and from the event monitoring service 35 or script 30 within the isolated environment 36 from being affected by events 32 with which they are not interested or may be considered insecure.

The event monitoring service 35 is shown by way of example in FIG. 4 to illustrate that event monitoring may be controlled to perform event detection either on behalf of the script 30 as shown in FIG. 4 or instead of using such a script 30. It can therefore be appreciated that the event monitoring service 35 is shown for illustrative purposes and may be implemented in other ways. Similarly, it can be appreciated that the event monitoring service 35 may be implemented in the configuration shown in FIG. 2, that is, outside of an isolated environment 36. Moreover, a single event monitoring service 35 may be deployed to service multiple different event detection scripts 30, e.g., using a common set of delivery semantics 31.

The event monitoring service 35 may be provided within the isolated environment 36 to control the detection and processing of events for the script 30. For example, the event monitoring service 35 may subscribe to an event-related topic in an event/message stream broadcast by the application 16 in either a push or pull configuration.

For example, in a pull configuration, the events 32 that are triggered by interactions with the application 16 may be pulled by the event monitoring service 35 into the isolated environment 36 for processing by the script 30 and multiple in-memory queues 28 according to the delivery semantics 31.

In a push configuration, the event monitoring service 36 may be configured such that events 32 are received or otherwise pushed thereto by a script 30 outside of the isolated environment 36 or from another service (not shown).

The script 30 shown outside of the isolated environment 36 in FIG. 4 may operate independently of the isolated environment 36 and provide events 32 or event-related data directly to the analytics engine 18 via a network interface 24 or via a queue 28 located in the isolated environment 36. Events 32 may also originate within the application 16 and outside of the isolated environment 36, and be detected by the event monitoring service 35, the script 30 or both, using a push or pull paradigm.

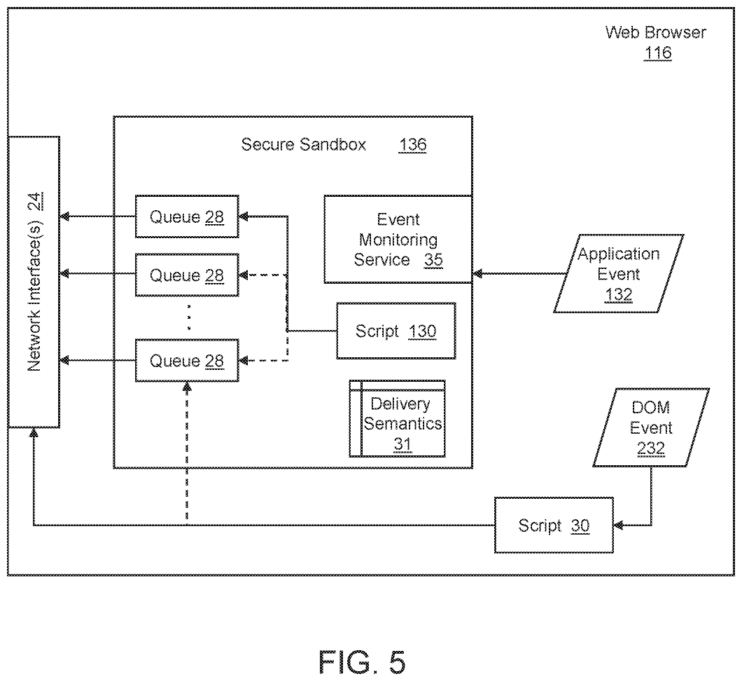

Referring now to FIG. 5, a web browser 116 is shown as a type of application 16 that may utilize the event monitoring service 35, script 130, and in-memory queues 28 within a secure sandbox 136. In this example, application events 132 such as a form entry, shopping cart add or removal, purchase, etc. may be detected using a script 130 and event monitoring service 35 deployed within the secure sandbox 136. This allows the delivery semantics 31 and the logic associated with the script 130 and event monitoring service 35 to be protected and isolated from other events 32, such as standard browser events such as DOM-related events 232 that routinely occur within the web browser 116.

As shown, the DOM-related events 232 may be detected by a separate script 30 deployed outside of the secure sandbox 136 and related to some other analytics or monitoring service (not shown). That is, the secure sandbox 136 may provide a controlled and secure abstraction layer for the analytics engine 18 and any entity concerned with the data associated with the application events 132, e.g., a platform tenant such as a merchant.

The abstraction layer allows the application 16, software platform 12, analytics engine 18 or an administrative entity within the computing environment 10 to customize the analytics, event detection parameters, monitoring subscriptions, or other modifiable elements of the event detection configurations shown herein. By abstracting within an isolated environment 36, these event detection configurations may be implemented in a secure manner, particularly when the software platform 12 provide multiple tenant domains 34 with different sensitivities or security requirements.

The configurations shown in FIGS. 4 and 5 enable different subscribers to subscribe to various levels or amounts of event monitoring by the event monitoring service 35, including on a queue-by-queue basis. For example, one subscriber may be interested in the data placed in all of the queues 28 while another subscriber may be interested in only a subset of the queues 28. The analytics engine 18, for example, may be configured to monitor certain types of events 32, all events 32 by a tenant domain 34 of the software platform 12, or may be configured to monitor only certain applications 16 within a tenant domain 34. As such, the isolated environment 36, e.g., a secure sandbox 136, inline frame or other secure zone or area; may be configured to suit a particular entity using (or associated with) the software platform 12 and its applications 16. Such configurability may be provided by a subscription with the analytics engine 18 or via a monitoring service subscription provided by the software platform 12.

In certain example embodiments, it can be appreciated that the event monitoring operations described herein may, additionally or alternatively, include calls to other third party entities or sources not shown in FIGS. 1-5 for ease of illustration. For example, the analytics engine 18 may interact with other third party entities to provide subscription services to tenants of the software platform 12.

FIG. 6 shows an example of a computing device 40 which may be utilized by any one or more of the entities shown in FIG. 1, for example, a server used to provide the software platform 12 (e.g., server for application(s) 16), a server or other computing device used to provide the analytics engine 18, a tenant of the software platform database 14, or client device 20; and be adapted for the corresponding role of that entity.

In this example, the computing device 40 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 40 may also include an application 16, 52 (e.g., a client-side application 52 corresponding to one or more of the server-side applications 16 provided by the platform 12 or the server-side application when the computing device 40 corresponds to a server for the software platform 12), a data store 54, and client application data 56.

The data store 54 may represent a database or library or other computer-readable medium configured to store data and permit retrieval of data by the computing device 40. The data store 54 may be read-only or may permit modifications to the data. The data store 54 may also store both read-only and write accessible data in the same memory allocation. In this example, the data store 54 stores the application data 56 for the application 16, 52 that is configured to be executed by the computing device 40 for a particular role or purpose.

While not delineated in FIG. 6, the computing device 40 includes at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 6 illustrates examples of modules and applications stored in memory on the computing device 40 and executed by the processor(s) 42.

It can be appreciated that any of the modules and applications shown in FIG. 6 may be hosted externally and may be available to the computing device 40, e.g., via a network interface 44. The data store 54 in this example stores, among other things, the application data 56 that can be accessed and utilized by the application 16, 52. The data store 54 may additionally store one or more software functions or routines in a cache or in other types of memory.

As shown in FIG. 6, the computing device 40 may, optionally (e.g., when configured as a client device 20), include a display 46 and one or more input device(s) 48 that may be utilized via an input/output (I/O) module 50. That is, such components may be omitted when the computing device 40 does not interact with a user.

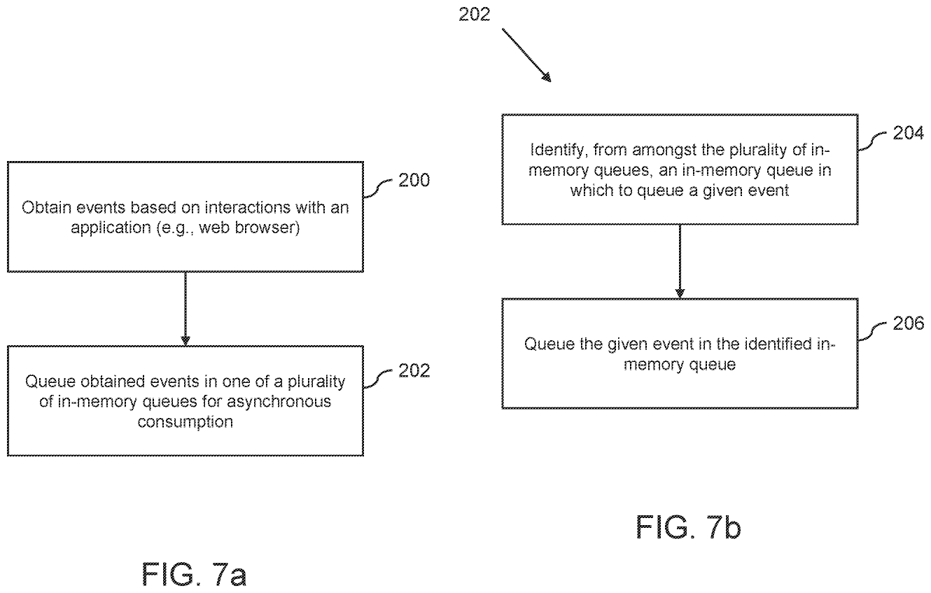

FIG. 7a is a flow chart illustrating example operations performed in queueing events 32 for asynchronous consumption. At block 200, a script 30, event monitoring service 35 or both, obtains events 32 based on interactions with an application 16 such as a web browser 116.

At block 202, the obtained events 32 are queued in one of a plurality of in-memory queues 28 for asynchronous consumption, e.g., based on an event type, a priority parameter or a timing parameter as discussed above.

FIG. 7b is a flow chart illustrating example operations performed in queueing events 32 to one of a plurality of in-memory queues 28, e.g., performed within block 202 shown in FIG. 7a.

At block 204, the script 30 or event monitoring service 35 uses, for example, the delivery semantics 31 to identify, from amongst the plurality of in-memory queues 28, a particular in-memory queue 28 in which to queue a given event 32 and, at block 206, the given event 32 is queued in the identified in-memory queue 28.

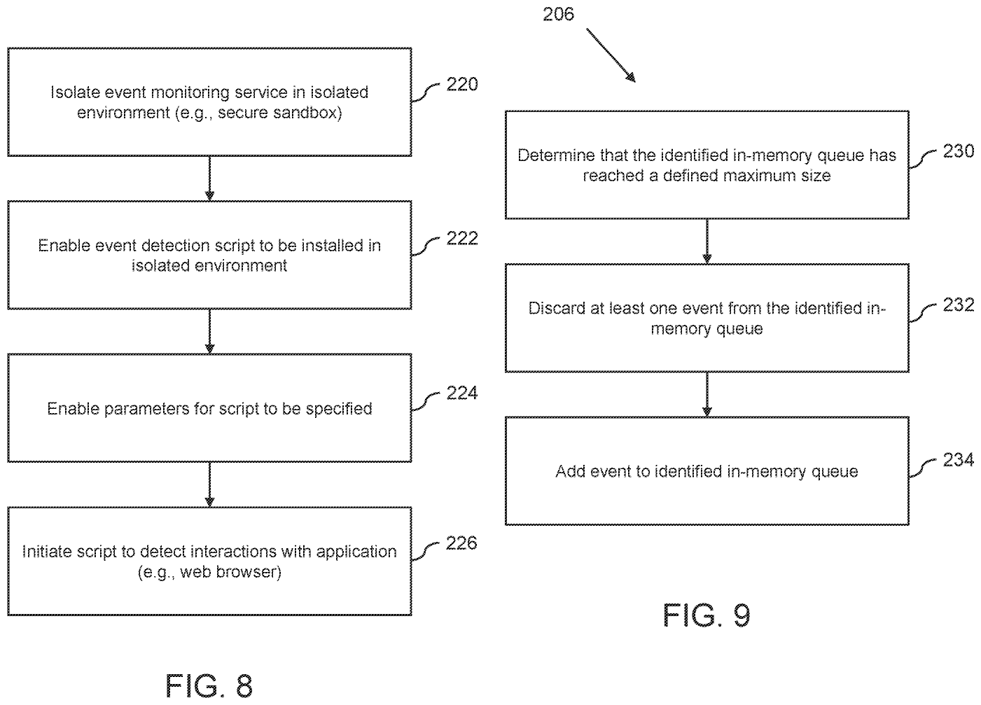

FIG. 8 is a flow chart illustrating example operations performed in isolating event detection scripts 30 in an isolated environment 36 such as in a secure sandbox 136. At block 220, an event monitoring service 35 may be isolated in an isolated environment 36 such as the secure sandbox 136 shown in FIG. 5. The event detection script 30 may be installed in the isolated environment 36 at block 222.

At block 224, parameters for the script 30 may be specified, e.g., by enabling an entity such as a tenant of the platform 12 or an administrator or user of the analytics engine 18 to specify such parameters. The parameters may relate to the event types, event priorities, and any delivery semantics 31 that may be applied to perform asynchronous consumption in the in-memory queues 28.

At block 226, the script 30 may be initiated to detect interactions with the application 16 (e.g., web browser 116) that may directly or indirectly trigger events 32.

FIG. 9 is a flow chart illustrating example operations performed in managing a queue 28 based on a defined maximum size. At block 230, the event monitoring service 35 or script 32 may determine that the identified in-memory queue 28 (e.g., at block 206 in FIG. 7b) has reached a defined maximum size. For example, the in-memory queue 28 for a relatively lower priority event 32 may have a limited size based on total storage space or number of events 32.

At block 232, the event monitoring service 35 or script 30 may discard at least one event 32 from the identified in-memory queue 28. This creates space for the given event 32 to be added to the identified in-memory queue 28 at block 234.

Similar operations to those shown by way of example in FIG. 9 may be replicated for different delivery semantics or parameters related to asynchronous consumption, such as by detecting a timing, event type, etc.

A differentiated quality of service may thus be achieved by queuing up events 32 into selected ones of multiple in-memory queues 28 for asynchronous consumption, e.g., by having asynchronous transmissions of events 32 to a remote server such as the analytics engine 18. Put another way, the differentiated quality of service may be achieved by applying different “delivery semantics” to each of multiple in-memory queues 28. The delivery semantics may be associated with the asynchronous consumption in addition to other factors like queue size, queue element expiration, etc.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method, comprising:
obtaining events based on interactions with a web browser; and
queueing the obtained events for each of the events, the queuing comprising, for a given event:
identifying, from amongst a plurality of in-memory queues based on the given event, an in-memory queue in which to queue the given event; and
queuing the given event in the identified in-memory queue;
wherein the events queued in the queues of the plurality of in-memory queues are queued for asynchronous consumption.

2. The method of claim 1, wherein the obtained events are generated based on interactions with the web browser.

3. The method of claim 2, wherein the interactions with the web browser are detected by an event detection script or event monitoring service securely isolated from the web browser, the event detection script or event monitoring service used to queue events according to one or more delivery semantics associated with the asynchronous consumption.

4. The method of claim 3, wherein the event detection script or event monitoring service is securely isolated from the web browser using an inline frame.

5. The method of claim 3, wherein the event detection script or event monitoring service is securely isolated from the web browser using a secure sandbox.

6. The method of claim 2, wherein the identified in-memory queue comprises events queued for responding to a replay request.

7. The method of claim 1, wherein the identified in-memory queue is identified based on a type of the given event.

8. The method of claim 1, wherein queueing the given event in the identified in-memory queue comprises, prior to adding the given event to the identified in-memory queue:
determining that the identified in-memory queue has reached a defined maximum size; and
discarding at least one event from the in-memory queue.

9. The method of claim 8, wherein the discarded at least one event from the identified in-memory queue is selected based on a position of the at least one event in the identified in-memory queue.

10. The method of claim 1, wherein the asynchronous consumption comprises asynchronous transmissions of events to a remote server.

11. The method of claim 1, wherein at least some of the obtained events correspond to document object model (DOM)-related events.

12. The method of claim 1, wherein the identified in-memory queue has a relatively higher capacity than at least one other in-memory queue of the plurality of in-memory queues.

13. The method of claim 12, wherein the at least one other in-memory queue is associated with at least one other event type having a relatively lower priority than a type of the given event.

14. The method of claim 1, wherein the plurality of in-memory queues comprises three or more event queues including the identified in-memory queue, at least some of the three or more in-memory queues having a different priority level.

15. The method of claim 14, wherein each of the three or more in-memory queues comprises a corresponding capacity based on a corresponding priority level.

16. The method of claim 14, wherein each of the three or more in-memory queues transmits events to a remote server asynchronously based on a corresponding priority level.

17. A computer system comprising:
at least one processor; and
at least one memory, the at least one memory comprising processor executable instructions that, when executed by the at least one processor, cause the computer system to:
obtain events based on interactions with a web browser; and
queue the obtained events for each of the events, the queuing comprising, for a given event:
identifying, from amongst a plurality of in-memory queues based on the given event, an in-memory queue in which to queue the given event; and
queuing the given event in the identified in-memory queue;
wherein the events queued in the queues of the plurality of in-memory queues are queued for asynchronous consumption.

18. The computer system of claim 17, wherein the obtained events are generated based on interactions with the web browser.

19. The computer system of claim 18, wherein the interactions with the web browser are detected by an event detection script or event monitoring service securely isolated from the web browser, the event detection script or event monitoring service used to queue events according to one or more delivery semantics associated with the asynchronous consumption.

20. A computer-readable medium comprising processor executable instructions that, when executed by a processor of a computer system, cause the computer system to:
obtain events based on interactions with a web browser; and
queue the obtained events for each of the events, the queuing comprising, for a given event:
identifying, from amongst a plurality of in-memory queues based on the given event, an in-memory queue in which to queue the given event; and
queuing the given event in the identified in-memory queue;
wherein the events queued in the queues of the plurality of in-memory queues are queued for asynchronous consumption.
